(19) United States
(12) Patent Application Publication
(10) Pub. No.: US 2022/0055562 A1
(43) Pub. Date: Feb. 24, 2022

(54) BUMPER DEVICE

(71) Applicants: Toyota Jidosha Kabushiki Kaisha, Toyota-shi Aichi-ken (JP); Subaru Corporation, Tokyo (JP)

(72) Inventors: Osamu Watanabe, Toyota-shi (JP); Osamu Shimasaki, Nisshin-shi (JP); Shinji Nakano, Tokyo (JP)

(73) Assignees: Toyota Jidosha Kabushiki Kaisha, Toyota-shi Aichi-ken (JP); Subaru Corporation, Tokyo (JP)

(21) Appl. No.: 17/365,363

(22) Filed: Jul. 1, 2021

(30) Foreign Application Priority Data
Aug. 24, 2020 (JP) 2020-141143

(51) Int. Cl. B60R 19/34

(52) U.S. Cl. CPC B60R 19/34

(57) ABSTRACT

A bumper device includes a bumper reinforcement, a crush box, and a lashing nut. The bumper reinforcement has a plate portion constituting an outer-side surface of the bumper reinforcement. The crush box includes a cylindrical portion that is disposed at a position closer to a cabin than the plate portion, and that is fixed to the plate portion in an orientation in which an axial direction of the cylindrical portion extends in a front-rear direction of a vehicle. The lashing nut is disposed within the cylindrical portion in an orientation in which an axial direction of the lashing nut extends in the front-rear direction of the vehicle. The lashing nut is connected to the plate portion. The lashing nut is unconstrained with respect to an inner face of the cylindrical portion.

### CROSS-REFERENCE TO RELATED APPLICATION

This application claims priority to Japanese Patent Application No. 2020-141143 filed on Aug. 24, 2020, incorporated herein by reference in its entirety.

### BACKGROUND

### 1. Technical Field

The technology disclosed in the present specification relates to a bumper device.

### 2. Description of Related Art

Japanese Unexamined Patent Application Publication 2016-132269 (JP 2016-132269 A) discloses a bumper device that has a lashing nut. The lashing nut is fixed to bumper reinforcement. Lashing nuts are used to fix towing hooks to the body. A crush box is also connected to the bumper reinforcement. The crush box has a cylindrical portion, with a front end of the cylindrical portion fixed to the bumper reinforcement. The lashing nut is disposed within the cylindrical portion of the crush box. Disposing the lashing nut within the cylindrical portion of the crush box in this way enables a space within the cylindrical portion to be utilized effectively. A front end portion of the lashing nut is connected to the front end of the crush box by a bracket. A rear end portion of the lashing nut is connected to the inner face of the crush box by another bracket.

### SUMMARY

When a load is applied to the bumper reinforcement due to a vehicle collision, the crush box collapses, thereby absorbing collision energy. In the bumper device according to JP 2016-132269 A, the front end portion and the rear end portion of the lashing nut are each connected to the crush box. Also, the lashing nut is sturdy and does not readily deform. Accordingly, the crush box does not readily collapse in a range between the front end portion and the rear end portion of the lashing nut. Hence, the collision energy that the crush box can absorb at the time of a collision of the vehicle is small. The present specification proposes a technology in which more collision energy can be absorbed by a crush box in a bumper device that has a lashing nut.

A bumper device disclosed in the present specification includes a bumper reinforcement, a crush box, and a lashing nut. The bumper reinforcement has a plate portion constituting an outer-side surface of the bumper reinforcement. The crush box includes a cylindrical portion that is disposed at a position closer to a cabin than the plate portion, and that is fixed to the plate portion in an orientation in which an axial direction of the cylindrical portion extends in a front-rear direction of a vehicle. The lashing nut is disposed within the cylindrical portion, and is fixed to the plate portion in an orientation in which an axial direction of the lashing nut extends in the front-rear direction of the vehicle. The lashing nut is unconstrained with respect to an inner face of the cylindrical portion.

Note that “the lashing nut is unconstrained with respect to an inner face of the cylindrical portion” means that there is no structural member connecting and fixing the lashing nut and the inner face of the cylindrical portion to each other. That is to say, this means that there is no structural member that would impede relative movement of the lashing nut and the cylindrical portion existing between the lashing nut and the inner face of the cylindrical portion. Note that a soft member (e.g., a wire or the like) connecting between the lashing nut and the inner face of the cylindrical portion may be present. Such a soft member does not impede relative movement of the lashing nut and the cylindrical portion, and accordingly does not constrain the lashing nut to the inner face of the cylindrical portion.

Also, the “outer-side surface” of the bumper reinforcement means the surface of the bumper reinforcement that is facing the outer side of the vehicle. In a bumper device on the front side of the vehicle, the outer-side surface is the front face of the bumper reinforcement. In a bumper device on the rear side of the vehicle, the outer-side surface is the rear face of the bumper reinforcement.

In the above bumper device disclosed in the present specification, the lashing nut disposed within the cylindrical portion of the crush box is fixed to the cylindrical portion through the bumper reinforcement. On the other hand, the lashing nut is unconstrained with respect to the inner face of the cylindrical portion. Accordingly, the crush box can collapse without being supported by the lashing nut at the time of a collision of the vehicle. Therefore, the crush box can readily collapse across the range in which the lashing nut is present. Thus, according to this bumper device, more collision energy can be absorbed by the crush box.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a vehicle having a bumper device according to an embodiment;

FIG. 2 is a perspective view of the bumper device according to the embodiment;

FIG. 3 is a longitudinal-sectional view of the bumper device at a position of a lashing nut (sectional view at the position of line III-III in FIG. 2);

FIG. 4 is a cross-sectional view of the bumper device at the position of the lashing nut (sectional view at the position of line IV-IV in FIG. 2); and

FIG. 5 is a longitudinal-sectional view of a bumper device according to a comparative example corresponding to FIG. 3.

### DETAILED DESCRIPTION OF EMBODIMENTS

A bumper device of a vehicle according to an example disclosed in the present specification may further include a first bracket that connects a first portion of the lashing nut to the plate portion, and a second bracket that connects, to the plate portion, a second portion of the lashing nut, the second portion being disposed at a position closer to the cabin than the first portion.

Note that the first bracket and the second bracket may be integral with the crush box, or may be integral with the bumper reinforcement. That is to say, the first bracket and the second bracket may be configured as part of the crush box, or the first bracket and the second bracket may be configured as part of the bumper reinforcement.

According to this configuration, the lashing nut can be connected to the plate portion at a plurality of positions in the front-rear direction of the vehicle, and accordingly the lashing nut can be fixed to the plate portion more strongly.

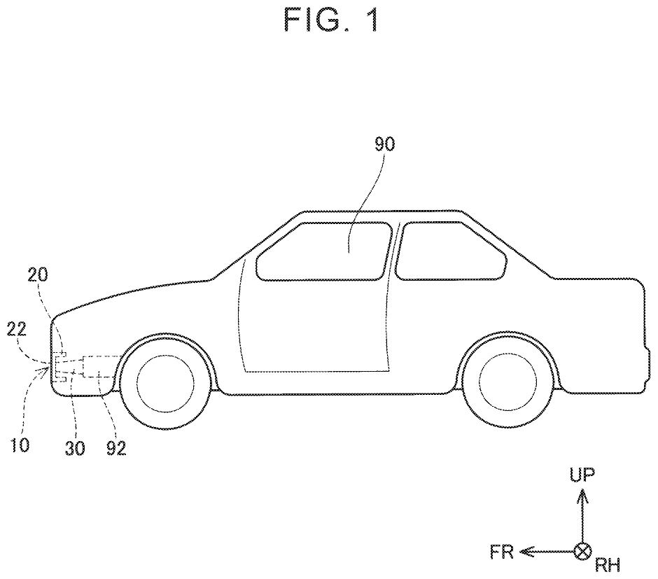

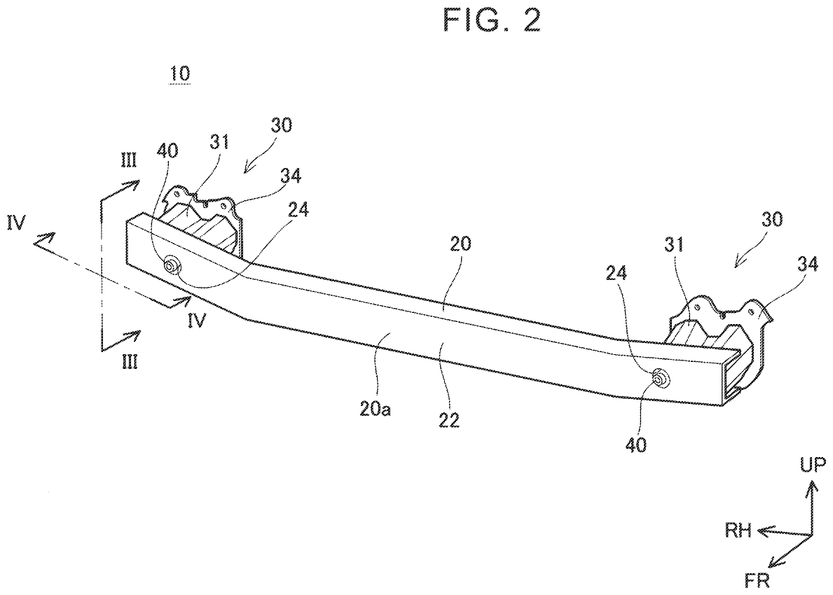

As illustrated in FIG. 1, a bumper device 10 according to an embodiment is attached to a front portion of a vehicle. In the drawings including FIG. 1, the arrow FR indicates the vehicle forward direction, the arrow UP indicates the vehicle upward direction, and the arrow RH indicates the vehicle right direction. As illustrated in FIG. 2, the bumper device 10 has a bumper reinforcement 20, two crush boxes 30, and two lashing nuts 40.

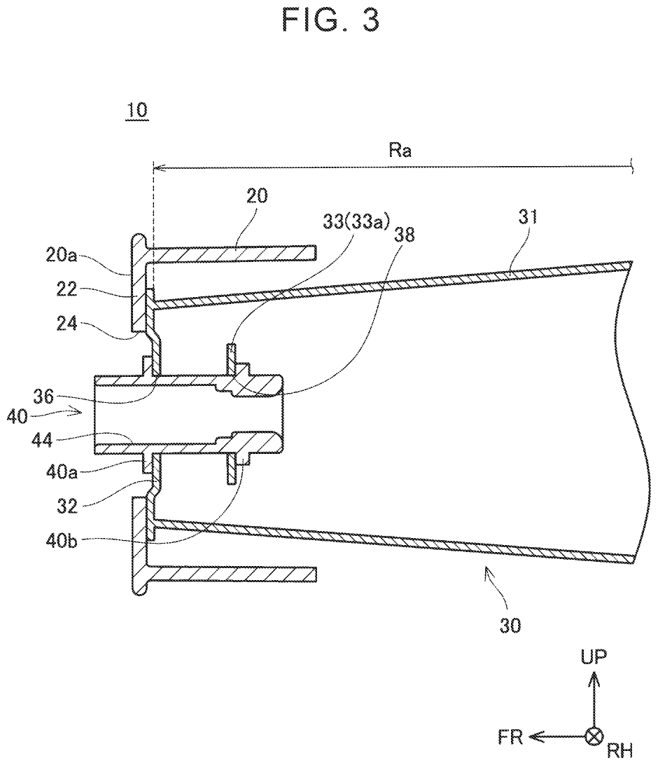

As illustrated in FIG. 2, the bumper reinforcement 20 is elongated in the vehicle width direction. As illustrated in FIG. 3, the bumper reinforcement 20 has a square letter-U shape longitudinal-sectional form. The bumper reinforcement 20 is fixed in an orientation in which the bottom face of the letter-U shape faces forward. Hereinafter, a plate-like portion constituting a front face 20a of the bumper reinforcement 20 will be referred to as “plate portion 22”.

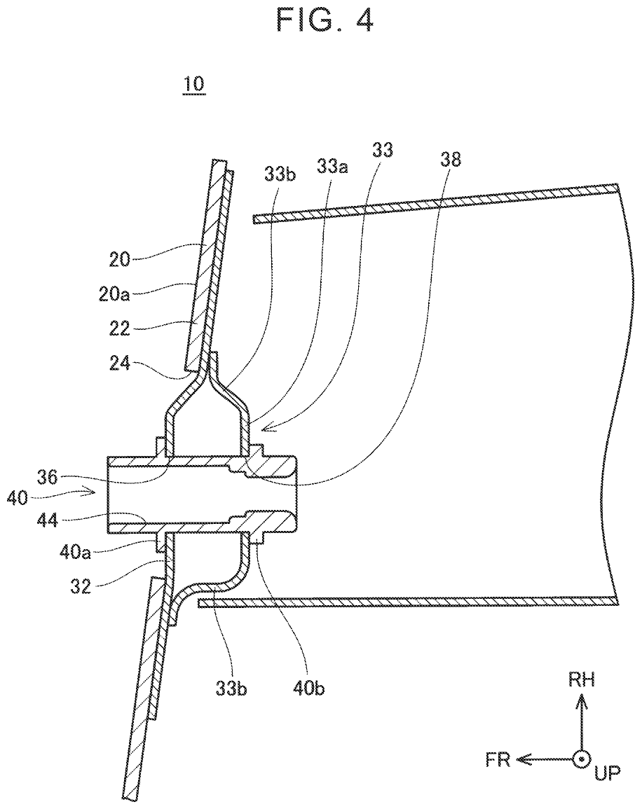

As illustrated in FIG. 2, the two crush boxes 30 are disposed rearward of the bumper reinforcement 20. Accordingly, the crush boxes 30 are each disposed at positions nearer to a cabin 90 than the plate portion 22 of the bumper reinforcement 20, as illustrated in FIG. 1. As illustrated in FIG. 2, the crush boxes 30 are each disposed on the right and left rear end portions of the bumper reinforcement 20. Each crush box 30 is connected to the plate portion 22 at the front end thereof. Each crush box 30 has a cylindrical portion 31, a forward bracket 32, a rearward bracket 33, and a flange 34, as illustrated in FIGS. 2 through 4. The cylindrical portion 31 is disposed in an orientation in which the axial direction thereof extends in the front-rear direction of the vehicle. The forward bracket 32 extends following the plate portion 22 of the bumper reinforcement 20, as illustrated in FIGS. 3 and 4. The front face of the forward bracket 32 is fixed to the rear face of the plate portion 22 by welding or the like. The rear face of the forward bracket 32 is fixed to the front end of the cylindrical portion 31 by welding or the like. Accordingly, the front end of the cylindrical portion 31 is fixed to the plate portion 22 through the forward bracket 32. Thus, the crush box 30 is fixed to the plate portion 22 in an orientation in which the axial direction of the cylindrical portion 31 extends in the front-rear direction of the vehicle. The rearward bracket 33 is disposed within the cylindrical portion 31. The rearward bracket 33 is disposed rearward of the forward bracket 32. A principal portion 33a of the rearward bracket 33 extends following the forward bracket 32 at a position spaced from the forward bracket 32. As illustrated in FIG. 4, the rearward bracket 33 has connecting portions 33b on both ends of the principal portion 33a (both ends in the right-left direction of the vehicle). The connecting portions 33b are bent from the principal portion 33a and extend forward. The front ends of the connecting portions 33b are fixed to the rear face of the forward bracket 32 by welding or the like. As illustrated in FIG. 2, the flanges 34 are provided at the rear ends of the cylindrical portions 31. As illustrated in FIG. 1, the rear end portions of the crush boxes 30 (i.e., the flanges 34 illustrated in FIG. 2) are connected to a member constituting the body of the vehicle (e.g., a front side member 92). The thickness of the steel sheet constituting the cylindrical portions 31 of the crush boxes 30 is less than the thickness of the steel sheet constituting the bumper reinforcement 20. Accordingly, the crush boxes 30 can easily collapse at the time of a front-end collision of the vehicle. Due to the crush boxes 30 collapsing, collision energy is absorbed by the crush boxes 30.

As illustrated in FIGS. 3 and 4, through holes 24 are provided in the plate portion 22 of the bumper reinforcement 20. Through holes 36 are provided in the forward brackets 32 located within the through holes 24. The diameter of the through holes 36 is smaller than that of the through holes 24. Through holes 38 are provided in the rearward brackets 33 at positions rearward of the through holes 36. The lashing nuts 40 have cylindrical forms, and pass through the through holes 24, 36, and 38. The lashing nuts 40 are disposed within the cylindrical portions 31 of the crush boxes 30. A forward flange 40a and a rearward flange 40b are provided on the outer circumferential face of each lashing nut 40. The forward flanges 40a are disposed forward of the forward brackets 32. The forward flanges 40a are fixed to the front face of the forward brackets 32 at the periphery of the through holes 36 by welding or the like. Accordingly, the forward flanges 40a are connected to the plate portion 22 of the bumper reinforcement 20 by the forward brackets 32. The rearward flanges 40b are disposed rearward of the rearward brackets 33. The rearward flanges 40b are fixed to the rear face of the rearward brackets 33 at the periphery of the through holes 38 by welding or the like. Accordingly, the rearward flanges 40b are connected to the plate portion 22 of the bumper reinforcement 20 by the rearward bracket 33 and the forward bracket 32. Thus, the lashing nuts 40 are connected to the plate portion 22 of the bumper reinforcement 20 by the forward brackets 32 and the rearward brackets 33. The lashing nuts 40 are fixed to the plate portion 22 in an orientation in which the axial directions thereof extend following the front-rear direction of the vehicle. The lashing nuts 40 are fixed at positions that are visually recognizable within the through holes 24 when the plate portion 22 is viewed from a forward position. Screw threads are formed on inner holes 44 of the lashing nuts 40. Vehicle lashing hooks can be attached to the lashing nuts 40 from the front side of the plate portion 22. The thickness of the metal constituting the lashing nuts 40 is greater than the thickness of the steel sheet constituting the cylindrical portions 31 of the crush boxes 30. Accordingly, the lashing nuts 40 have greater strength than the cylindrical portions 31. Hence, the lashing nuts 40 do not readily deform at the time of a front-end collision of the vehicle.

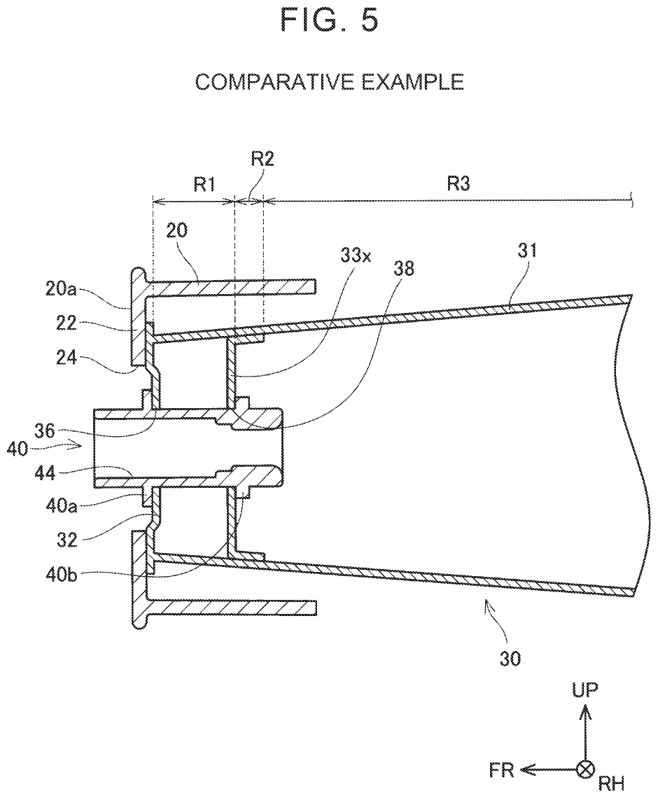

Next, a difference between a bumper device according to a comparative example illustrated in FIG. 5 and the bumper device 10 according to the embodiment will be described. As illustrated in FIG. 5, the rearward flange 40b of the lashing nut 40 is connected to the inner face of the cylindrical portion 31 by a rearward bracket 33x in the bumper device according to the comparative example. Other configurations of the bumper device according to the comparative example are equivalent to those of the bumper device 10 according to the embodiment.

In the bumper device according to the comparative example, the forward flange 40a of the lashing nut 40 is connected to the plate portion 22 by the forward bracket 32, and the rearward flange 40b of the lashing nut 40 is connected to the inner face of the cylindrical portion 31 by the rearward bracket 33x. Also, the lashing nut 40 has a greater strength than the cylindrical portion 31, as described earlier. At the time of a front-end collision of a vehicle equipped with the bumper device according to the comparative example, a rearward load is placed on the bumper reinforcement 20, and the cylindrical portion 31 collapses in the axial direction (the front-rear direction of the vehicle). At this time, in a range R1 between the forward bracket 32 and the rearward bracket 33x, the cylindrical portion 31 is supported by the lashing nut 40 that has a high level of strength, and accordingly the cylindrical portion 31 can hardly collapse at all. Also, the cylindrical portion 31 can hardly collapse at all in the range R2 in which the rearward bracket 33x and the cylindrical portion 31 are welded. That is to say, at the time of a collision, the cylindrical portion 31 collapses in a range R3 that is rearward of the rearward bracket 33x, but hardly collapses in the ranges R1 and R2 that are forward of the range R3. Thus, part of the cylindrical portion 31 does not readily collapse in the bumper device according to the comparative example, and accordingly less collision energy is absorbed by the cylindrical portion 31.

Conversely, the bumper device 10 according to the embodiment does not have a member arranged to connect the lashing nut 40 and the inner face of the cylindrical portion 31 within the cylindrical portion 31, as illustrated in FIGS. 3 and 4. Accordingly, the lashing nut 40 is unconstrained with respect to the inner face of the cylindrical portion 31. Thus, at the time of a front-end collision of the vehicle, the cylindrical portion 31 is not supported by the lashing nut 40, and the cylindrical portion 31 can readily collapse over the entire range Ra in the axial direction thereof. Accordingly, more collision energy is absorbed by the cylindrical portion 31 in the bumper device 10 according to the embodiment.

As described above, in the bumper device 10 according to the embodiment, the lashing nuts 40 are not connected to the inner faces of the cylindrical portions 31, and the lashing nuts 40 are fixed to the cylindrical portions 31 through the plate portion 22 of the bumper reinforcement 20. Accordingly, the lashing nuts 40 do not support the cylindrical portions 31 at the time of a collision of the vehicle, and more collision energy can be absorbed by the cylindrical portions 31 collapsing almost entirely. Also, the lashing nuts 40 can be fixed to the plate portion 22 with sufficient strength, in the fixation configuration in which the lashing nuts 40 are connected to the plate portion 22 without being connected to the inner faces of the cylindrical portions 31. Particularly, the lashing nuts 40 are connected to the plate portion 22 at two positions separated in the front-rear direction (i.e., the forward flange 40a and the rearward flange 40b), whereby the lashing nuts 40 can be fixed to the plate portion 22 with a high level of strength.

Although the bumper device 10 on the front side of a vehicle has been described in the above-described embodiment, the same lashing nut fixation configuration as described in the embodiment above may be employed for a bumper device on the rear side of a vehicle.

Also, although the lashing nuts 40 are connected to the plate portion 22 via the brackets 32 and 33 in the above-described embodiment, the lashing nuts 40 may be directly connected to the plate portion 22.

Although an embodiment has been described above in detail, this is only an exemplification, and does not limit the Claims. The technology set forth in the Claims includes various modifications and alterations of the specific example exemplified above. Technical elements described in the present specification or the drawings exhibit technical utility, either singularly or through various types of combinations, and do not limit combinations set forth in the Claims at the time of application. Also, the technology exemplified in the present specification or the drawings may achieve a plurality of objects simultaneously, and achieving one of these objects in itself has technical utility.

What is claimed is:

1. A bumper device, comprising:
a bumper reinforcement;
a crush box; and
a lashing nut,
wherein the bumper reinforcement has a plate portion constituting an outer-side surface of the bumper reinforcement,
wherein the crush box includes a cylindrical portion that is disposed at a position closer to a cabin than the plate portion, and that is fixed to the plate portion in an orientation in which an axial direction of the cylindrical portion extends in a front-rear direction of a vehicle,
wherein the lashing nut is disposed within the cylindrical portion, and is fixed to the plate portion in an orientation in which an axial direction of the lashing nut extends in the front-rear direction of the vehicle, and
wherein the lashing nut is unconstrained with respect to an inner face of the cylindrical portion.

2. The bumper device according to claim 1, further comprising a first bracket that connects a first portion of the lashing nut to the plate portion, and a second bracket that connects, to the plate portion, a second portion of the lashing nut, the second portion being disposed at a position closer to the cabin than the first portion.
